(19) United States
(12) Patent Application Publication
(10) Pub. No.: US 2010/0179884 A1
(43) Pub. Date: Jul. 15, 2010

(54) Purchasing system and method for food service network

(75) Inventor: Jordan Glaser, Oyster Bay, NY (US)

Correspondence Address: DILWORTH & BARRESE, LLP, 1000 WOODBURY ROAD, SUITE 405, WOODBURY, NY, 11797, US

(73) Assignee: KLICK KITCHEN LLC

(21) Appl. No.: 12/321,036

(22) Filed: Jan. 14, 2009

(51) Int. Cl. G06Q 30/00

(52) U.S. Cl. 705/27; 705/26

(57) ABSTRACT

A purchasing system for food service industry professionals including a portal for a communication network, the portal including a buyer account registration area for processing buyer registrations; a vendor account registration area for processing vendor registrations; a login area for providing buyers and vendors access to either a buyer home area or a vendor home area; a buyer area for providing information about buyers; a vendor area for providing information about vendors; a contact area for food service industry professionals and vendors to communicate; an administrator contact area for communicating with a system administrator; a system information area for providing information about the system to buyers and vendors; and a system administrator area for providing information about the system administrators.

### FIELD OF THE INVENTION

This invention generally relates to purchasing systems and methods for the food service industry. More particularly, the present disclosure is directed to a web-based portal and communication purchasing system, which provides food service industry professionals the ability to communicate with and access information about vendors and distributors and their products, as well as purchasing products.

### BACKGROUND OF THE INVENTION

Conventional systems for ordering food which allow customers to place orders directly with a restaurant are known. For example, such conventional systems can include an online food ordering system, which allows customers to place orders with restaurants and then pick up their orders at the restaurant, and computer touch screen systems, for in-restaurant ordering applications.

These types of systems fail to provide food service industry professionals with the ability to, among other things, learn information about different vendors and/or distributors, compare prices or shipping schedules available from different vendors and/or distributors, or to place orders from food service professionals directly with the vendors and/or distributors.

Also known are price comparison systems that allow individuals to see lists of prices for specific products. Some of these price comparison systems provide a consumer with information for comparison shopping. See, for example U.S. Pat. Application Publication No. 2002/0111873 and U.S. Pat. Application Publication No. 2005/0137935. Still other comparison shopping may include a searching capability over the Internet to identify merchants' pricing for a product, and purchase the product from the system. See, for example, U.S. Pat. Application Publication No. 2002/0156685.

The systems discussed above, however fail to provide an interactive system that, among other things, provides interaction between food service industry professionals and vendors/distributors to allow food service industry professionals to place orders with multiple vendors, and then save, organize, process, confirm, and track the orders, while at the same time providing food service industry professionals access to information about vendors and distributors and their products, which the vendor/distributor can update/modify. Therefore, it would be desirable to overcome the disadvantages of the prior art with a purchasing system and method employing a web-based portal and communication system, which provides food service industry professionals the ability to communicate with and access information about vendors and distributors and their products, as well as purchases of present and non-present items.

### SUMMARY OF THE INVENTION

Accordingly, the present disclosure provides a purchasing system and method employing a web-based portal and communication system, which provides food service industry professionals the ability to communicate with and access information about vendors and distributors and their products, and vendors and distributors the ability to maintain/modify information relating to the goods or services they sell/provide. For a better understanding of the present invention, its operating advantages, and specific objects attained by its use, reference should be had to the drawings and descriptive matter in which there are illustrated and described preferred embodiments of the invention.

In one particular embodiment, the present invention relates to a purchasing system for food service industry professionals, and more particularly to a web-based portal and communication system that provides food service industry professionals, among other things, access to information about vendors and their products, as well as the ability to communicate with and order products from those vendors; while at the same time providing vendors the ability to, among other things, present information regarding themselves and their products, and the ability to communicate with food service industry professionals to, for example, negotiate price before an order is placed. Notably, by allowing vendors and food service industry professionals to negotiate price prior to purchase, the system of the subject invention allows vendors to provide food service industry professionals with custom quotes, specific to a given food service industry professional. It is recognized that by allowing vendors to offer different prices to different food service industry professionals that the system of the subject invention may be used as a tool for vendors to optimize pricing. Orders are saved, organized, processed, and tracked to allow for facile order management by vendors and re-ordering by food service industry professionals.

The system of the subject invention is a web portal that provides a website for an online purchasing system and marketing platform. In one embodiment of the subject invention, in order to access the web portal and use the system of the subject invention, food service industry professionals are required to register for a password-protected buyer account, which provides access to the web portal. The buyer account allows the food service industry professional to enter a profile that contains, among other things, general contact information and a description of his or her establishment. The buyer account also contains billing information, which is entered by the food service industry professional to be used when he or she wishes to make a purchase. The buyer account also allows food service industry professionals to select preferred vendors, in order to facilitate re-ordering. Indeed, it is recognized that many food service industry professionals often order the same products repeatedly from the same vendors. Accordingly, it is advantageous for a food service industry professional to have a list of preferred vendors which they can search through, rather than having to search through a long list of vendors or searching for a vendor by name. Likewise, it is advantageous for a food service professional to be able to access past orders to retrieve such information as product names or product sku or item numbers in order to facilitate re-ordering. It should be appreciated that a food service industry professional may optionally update and/or modify any information contained in his or her buyer account at any time to, among other things, change the location to which products are to be delivered or update the address to which notification e-mails are sent.

In one embodiment of the subject invention, vendors and distributors that cater to the food service industry set up a password-protected vendor account. Similar to a buyer account for a food service industry professional, a vendor account allows the vendor or distributor to enter a profile that contains among other things, general contact information, product information and pricing, as well as a description of his or her establishment. It should be appreciated that a vendor or distributor may optionally update and/or modify any information contained in his or her vendor account at any time to, among other things, add a new product or change pricing information or the description of an item. Bulk uploads are available for large edits.

The inventive system is fully interactive, thus allowing food service industry professionals to communicate with vendors and/or distributors, in order to, for example, ask a question, negotiate prices, or provide custom shipping instructions. In a preferred embodiment of the subject invention, communication between food service industry professionals and vendors occurs through the system of the subject invention, which directs messages entered through the system to e-mail addresses entered by system users, vendors and food service industry professionals alike. Notably, food service industry professionals and vendors are not required to leave the web portal in order to send a message. Moreover, in one embodiment, messages sent between food service industry professionals and vendors are not viewable by other food service industry professionals and/or vendors. In other words, vendors will not know, for example, what prices other vendors are offering to a specific food service industry professional. Likewise, a food service industry professional will not know, for example, what other food service industry professionals are purchasing items from a given vendor. Accordingly, communications are secure and confidential.

By allowing vendors and food service industry professionals (buyers) to negotiate prices, vendors may offer products for sale for prices which differ from the prices offered to the general public from, for example, the vendor's store or website. For example, should a vendor wish to give a certain food service industry professional a discount to encourage new business or reward past orders, the vendor could do so, through the system of the subject invention without altering the pricing for other food service industry professionals, including food service industry professionals which are registered as buyers with the inventive system. Moreover, by offering different prices to various food service industry professionals, a vendor may use the system of the subject invention to optimize pricing, without changing the prices offered to the general public. As such, the system of the subject invention may be used to test various marketing aspects using selected food service industry professionals without changing the way in which the vendor markets their goods to the general public.

The system of the subject invention contains a catalog of products that food service industry professionals can access to search for a specific product. In one embodiment, the subject invention allows food service industry professionals to search for products using a search engine to search terms or by browsing for products by category. The search engine allows vendors and distributors to search their products, and buyers the ability to search all products using a tag searching system. Search results are presented from both preferred vendors and featured vendors selected by the food service industry professional and all vendors. Search results provide item descriptions, prices, vendor product contact button, and vendor names. Food service industry professionals choose which item they wish to purchase and then add it to a cart by, for example, selecting the line item, entering the quantity, and hitting the enter button. Orders are placed by clicking on a send button in the cart. In one embodiment of the present invention, the system is not involved in invoicing, billing, delivery, and payment; which are the sole responsibility of the purchaser and the vendor.

The system of the subject invention also contains a vendor page that food service industry professionals can access to, inter alia, view information regarding a vendor, view the vendor's products, and contact the vendor. Communication between vendors and food service industry professionals occurs via the channel(s) chosen when set up the user accounts, typically e-mail mail and/or fax. Food service industry professionals may view a vendor's products by, for example, searching for products using a search engine to search terms or by browsing for products by category.

Orders are placed with one or more vendors and/or distributors directly through the system of the subject invention, and then saved, organized, processed, and tracked. The system tracks and stores all order information and history for each vendor and distributor as well as each buyer on a secure and private database. Vendors and/or distributors have the ability to confirm orders they receive through generated e-mails, as well as, edit pricing information for each item in each order, as well as, the entire order. Printing capability is enabled for all users and for all orders.

As discussed above, the inventive system permits a food service industry professional to order multiple products from multiple vendors within one order. Notably, a food service industry professional which desires to place an order need not be redirected to the website of a vendor or distributor to complete the order, regardless of the number of items being purchased or the number of vendors and/or distributors he or she is purchasing from. Vendors may optionally adjust prices for items after an order is placed by a food service industry professional. Accordingly, a vendor or distributor may opt to sell a particular item for a price other than the price advertised by the vendor.

Food service industry professionals may view past orders for simplified reordering, tracking and record keeping. Indeed, because many food service industry professionals order the same items from the same vendors repeatedly, it is advantageous to save past orders so that product information (e.g. product identification numbers or sku #) is readily accessible.

In one embodiment, a system administrator posts news about its vendors and distributors, along with updates about the portal in a news section, which is available to the portal's users and members, as well as to the public. In one embodiment of the present invention, all information, except news, is provided by the users and/or members of the portal (i.e. food service industry professionals and vendors). In another embodiment of the present invention, vendors/distributors and/or food service industry professionals may provide information related to the food service industry which is presented in the news section, and is viewable to other vendors/distributors and/or food service industry professionals.

A preferred embodiment of the system of the subject invention is subscription-based, where food service industry professionals, vendors, and distributors must all pay a subscription price to have access to the web portal. In one embodiment of the present invention, food service industry professionals, vendors, and distributors must all pay a monthly subscription price to have access to the web portal. In another embodiment of the subject invention, food service industry professionals, vendors and distributors may pay a fee each time they wish to access the web portal. In yet another embodiment of the present invention, food service industry professionals, vendors and distributors may pay a one-time fee for unlimited access to the web portal.

Other features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims.

### BRIEF DESCRIPTION OF DRAWINGS

In the drawings, wherein similar reference characters denote similar elements through the several views:

FIG. 1 is a flowchart illustrating an overview of the system of the subject invention demonstrating navigation of the system.

FIG. 2 is a flowchart illustrating the registration process of the system of the subject invention.

FIGS. 3-5 are flowcharts illustrating the ordering process of the system of the subject invention.

FIGS. 6 and 7 are flowcharts illustrating account management by a vendor in the system of the subject invention.

### DETAILED DESCRIPTION OF THE INVENTION

The exemplary embodiments of the purchasing system and methods of use for the food service industry, and more particularly in terms of a purchasing system and method employing a web-based portal and communication system, which provides food service industry professionals the ability to communicate with and access information about vendors and distributors and their products, and vendors and distributors the ability to maintain/modify information relating to the goods or services they sell/provide. It is envisioned that the purchasing system and method may be employed by caterers, restaurants, bistros, cafes, bakeries, snack bars, street vendors, coffee houses, bars, night clubs, theatres, hotels, casinos, and the like. It is further envisioned that the present disclosure may be employed with various types of vendors and/or distributors such as, for example, wholesalers, retailers, providers of after-market goods, foreign suppliers, and the like. It is contemplated that such vendors and/or distributors may include beverage, meat, dairy product, baking product, produce, seafood, canned and proceed food, condiment, gourmet food, and health food suppliers. It is further contemplated that food service industry professionals may include buyers such as caterers, restaurants, bistros, cafes, bakeries, snack bars, street vendors, coffee houses, bars, night clubs, theatres, hotels, casinos, and the like. It is envisioned that the network may include a Local Area Network (LAN), Wireless Local Area Network (WLAN), Wide Area Network (WAN), Metropolitan Area Network (MAN), Storage Area Network/System Area Network/Server Area Network/Small Area Network (SAN), Campus Area Network/Controller Area Network/Cluster Area Network (CAN), Personal Area Network (PAN), and Desk Area Network (DAN).

The present invention may be understood more readily by reference to the following detailed description of the invention taken in connection with the accompanying drawing figures, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention. Also, as used in the specification and including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

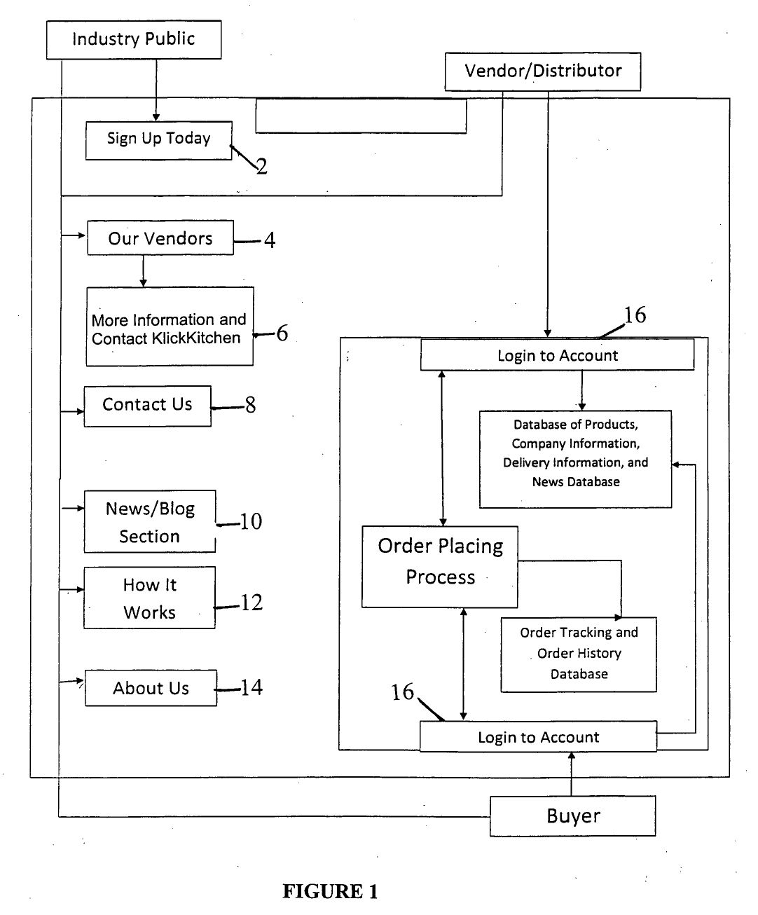

The following discussion includes a description of a purchasing system in accordance with the principles of the present disclosure. Alternate embodiments are also disclosed. Reference will now be made in detail to the exemplary embodiments of the present disclosure, which are illustrated in the accompanying figures. Turning now to FIG. 1 which illustrates an overview of a preferred embodiment of the instant invention demonstrating how a system user, such as a food service industry professional or a vendor, would navigate through the system's homepage. Specifically, a member of the industry public, such as a food service industry professional, who is not a member of the system may, among other things: (a) sign up for an account via sign up area 2; (b) view information concerning vendors via vendor area 4; (c) view more information about the vendor and contract KlickKitchen about sign up via information area 6; (d) contact a system administrator via administrator contact area 8; (e) access the system's news/blog section via news area 10; (f) learn about how the system works via system information area 12; and (g) learn about the system's administrators via system administrator area 14. In order to place orders however, a buyer may login to a buyer account via login area 16. Likewise, vendors/distributors may login to a vendor account via login area in order to access and/or modify their database of products, company information, delivery information, or the news database, for example. Once logged into their respective accounts, both buyers and vendors/distributors can track orders and view order history. It is recognized that system users comprise at least food service industry professionals, vendors and distributors that cater to food service industry professionals.

One of skill in the art will appreciate that a preferred embodiment of the system of the subject invention provides for a web portal which may include various dedicated servers for various links/areas, some of which were referred to hereinabove. For example, sign up area 2 may be connected to a dedicated server allowing for registration, and vendor area 4 may be connected to a dedicated server for providing information about vendors. Alternatively, the web portal of the subject invention may use only one network server. In either case, such specialized server applications are computer programs designed to handle multiple concurrent requests.

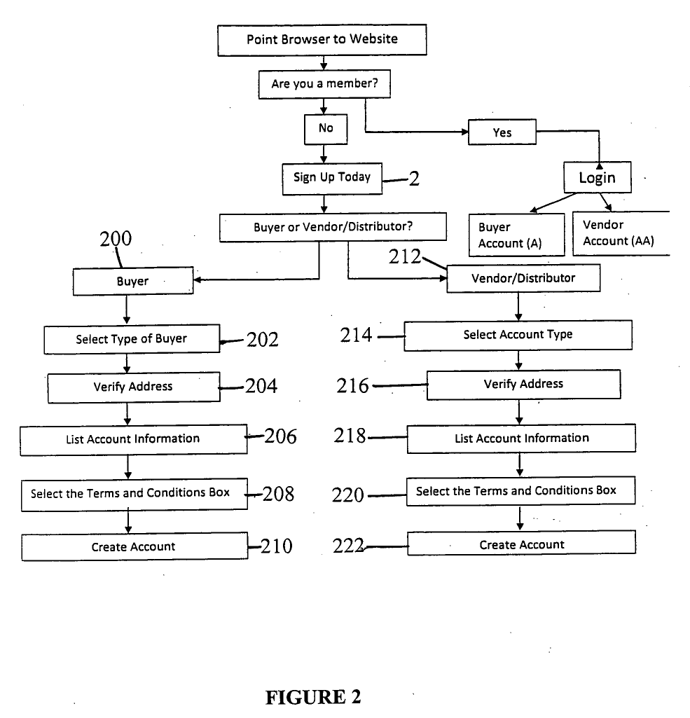

FIG. 2 illustrates the registration process of a preferred embodiment of the system of the subject invention. Specifically, a system user first gains access to the system's homepage, which is available to the public via the Internet. If the system user is not a member, they are prompted to register with the system via buyer account registration area 2. System users can register with the system as either a buyer (which would include food service industry professionals such as restaurant chefs or restaurant representatives) at step 200 or a vendor/distributor at step 212. It is understood that, for at least the purposes of the instant application, a food service industry professional encompasses those individuals who work for places, institutions, and companies which are involved in the preparation or processing of food. Vendors and/or distributors, on the other hand, are entities which cater to the food service industry professionals by offering for sale goods and/or services used by food service industry professionals.

As shown in FIG. 2, when registering, buyers are prompted to: (a) select the type of buyer by, for example, the type of cuisine their establishment features at step 202; and (b) enter and verify address information at step 204. A preferred embodiment of the instant invention, in addition to requesting address information, additionally requests the buyer to indicate the area in which the buyer is located (and hence would receive shipments). The system then compares the address information entered by the buyer (the buyer's location) against a database including the addresses for all vendors/distributors registered with the system to determine if there are any vendors/distributors which service the buyer's area(s). Account information, as entered by the buyer, is listed at step 206. If there are indeed vendors/distributors on the system which service the user's area, the user is prompted to: (a) accept certain terms and conditions at step 208; and (b) create an account profile at step 210, which contains, among other things, contact and billing information.

As shown in FIG. 2, when registering, vendors/distributors are prompted to: (a) select the type of account at step 214 according to, for example, the number of products the vendor/distributor wishes to list on the system; and (b) enter address information at step 216. A preferred embodiment of the instant invention, in addition to requesting address information, additionally requests the vendor/distributor to indicate the regions to which it provides its goods and/or services. The system then compares the address information entered by the vendor/distributor against a database including the addresses for all buyers registered with the system to determine if there are buyer's in the areas in which the vendor/distributor services. Account information, as entered by the vendor/distributor, is listed at step 218. If there are indeed users within the region(s) in which the vendors/distributors service, the vendor/distributor is prompted to: (a) accept certain terms and conditions at step 220; and (b) create an account profile at step 222, which contains, among other things, contact and billing information.

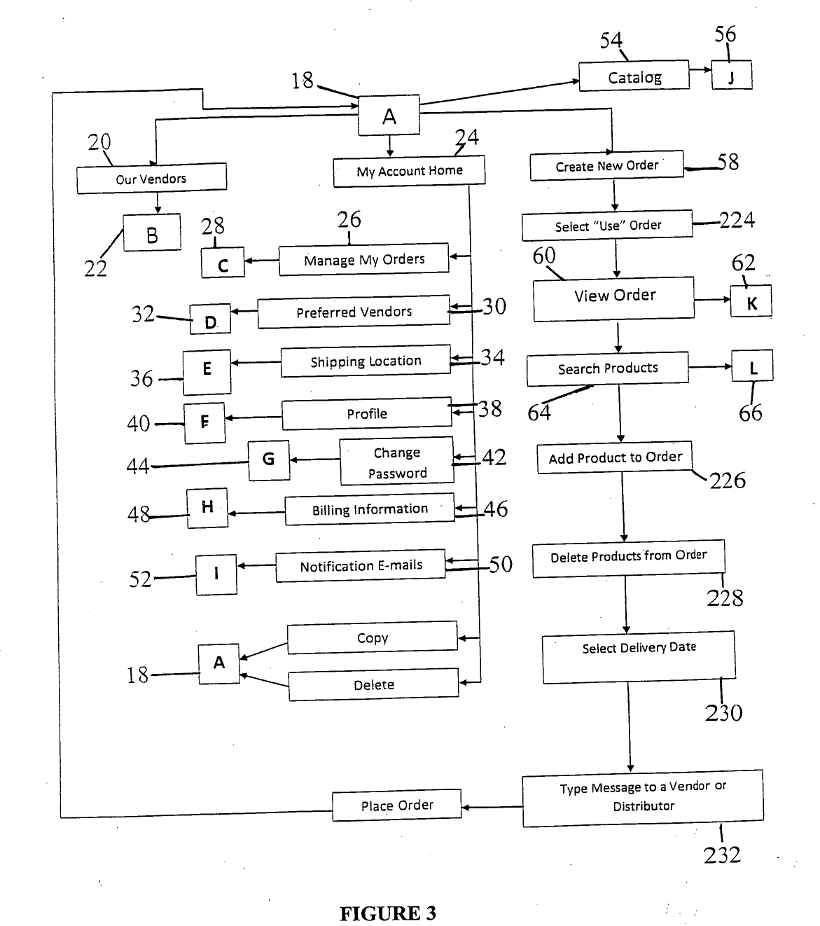

FIG. 3 illustrates use of a preferred embodiment of the system of the subject invention by a buyer interested in purchasing products or services. Specifically, after logging in using a user name and password, a food service industry professional gains access to food service industry professional homepage 18 which allows the food service industry professional to choose from among the following: (a) vendor area 20 which directs the food service industry professional to vendor module 22 that food service industry professionals can access to view information regarding a vendor; (b) buyer account area 24 which allows the food service industry professional to choose among the following: (i) buyer order management module 26 which directs the food service industry professional buyer order management module 28 that allows a buyer to organize, process and track orders; (ii) preferred vendor area 30 which directs the food service industry professional to preferred vendor module 32 that provides a list of the buyer's preferred vendors, as selected by the food service industry professional; (iii) shipping location area 34 which directs the food service industry professional to shipping location module 36 that allows a food service industry professional to update/modify shipping information; (iv) buyer profile area 38 which directs the food service industry professional to buyer profile module 40 that allows a food service industry professional to update/modify his or her profile; (v) buyer password area 42 which directs the food service industry professional to buyer password module 44 that allows a food service industry professional to change his or her user password; (vi) buyer billing information area 46 which directs the food service industry professional to buyer billing information module 48 that allows a food service industry professional to update/modify billing information used to place orders; (vii) buyer e-mail notification link 50 which directs the food service industry professional to buyer e-mail notification module 52 which allows a buyer to update/modify his or her e-mail contact information, which a user uses to communicate with vendors and/or buyers; (c) catalog area 54 which directs the user to catalog module 56 which provides the user access to a catalog listing products from vendors; or (d) new order area 58 which allows the user to create a new order by: (i) selecting “use” order at step 224; (ii) selecting view order area 60 which directs the user to view order module 62; (iii) selecting search product area 64 (which directs the user to search product search module 66); (iv) adding a product at step 226 or deleting a product at step 228; (v) selecting a delivery date at step 230; and (vi) optionally sending a message to a given vendor or distributor at step 232.

One of skill in the art will appreciate that system of the subject invention provides for a web portal which includes areas with links to various modules, which may or may not each have their own dedicated server. For example, vendor area 20 directs a food service industry professional to vendor module 22 that food service industry professionals can access to view information regarding a vendor.

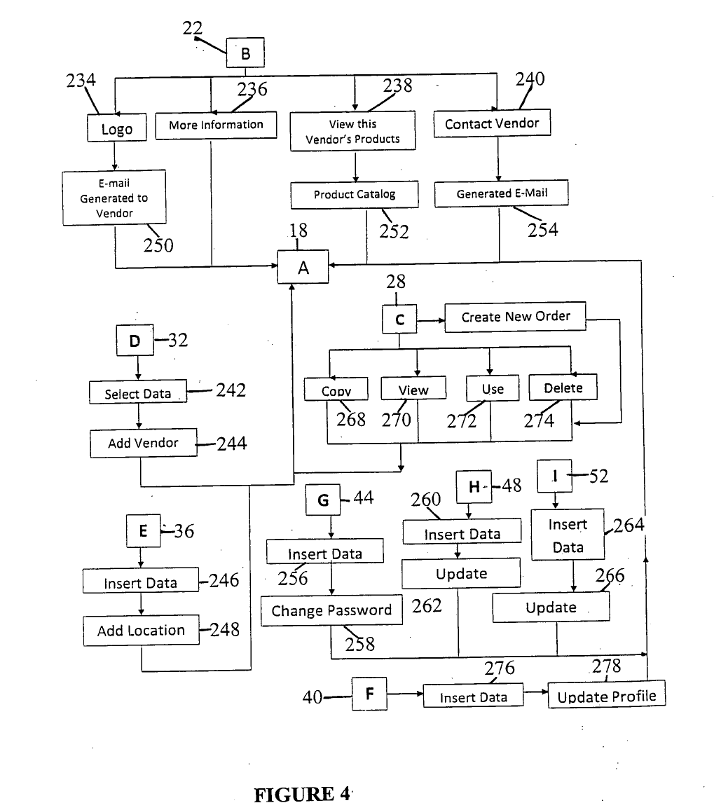

FIG. 4 illustrates how a buyer interested in purchasing products used in the food service industry uses a preferred embodiment of the system of the subject invention to purchase products through a vendor. Specifically, after logging in using a user name and password, a food service industry professional gains access to vendor module 22 via vendor area 20 (not shown). From vendor area 22 a food service industry professional can: (a) select a vendor logo at step 234 which generates an e-mail to the vendor at step 250; (b) get more information about a particular vendor at step 236; (c) view a vendor's products at step 238 which allows a food service industry professional to search for products in that vendor's inventory by using search terms or browsing for products by category at step 252; or (d) contact a vendor at step 240 through the subject invention via e-mail at step 254. After taking the desired action at vendor area 22, the food service professional is returned to buyer homepage 18.

As shown in FIG. 4, food service industry professionals may access preferred vendors module 32 in order to select data at step 242 in order to add a vendor to the food service industry professional's list of food vendors at step 244, which is maintained on the system of the subject invention. After taking the desired action at preferred vendor module 32, the food service professional is returned to buyer homepage 18 where he or she can select at least 1 of at least 8 options.

As shown in FIG. 4, shipping location module 36 allows food service industry professionals to insert data at step 246 in order to add a shipping location at step 248 to which future orders for goods from vendors would be delivered. After taking the desired action at shipping location module 36, the food service professional is returned to buyer homepage 18 where he or she can select at least 1 of at least 8 options.

In a preferred embodiment of the subject invention, both vendors and food service industry professionals are required to enter a user name and password in order to access the system of the subject invention. As shown in FIG. 4, buyer password module 44 allows food service industry professionals to insert data at step 256 to change their user password for the system of the subject invention at step 258. After taking the desired action at buyer password module 44, the food service professional is returned to buyer homepage 18 where he or she can select at least 1 of at least 8 options.

As shown in FIG. 4, buyer billing information module 48 allows food service industry professionals to insert data at step 260 to update their billing information at step 262, which in connection with orders placed with vendors through the system of the subject invention. After taking the desired action at buyer billing information module 48, the food service professional is returned to buyer homepage 18 where he or she can select at least 1 of at least 8 options.

As shown in FIG. 4, buyer e-mail notification module 52 allows food service industry professionals to insert data at step 264 to allow a food service industry professional to update/modify his or her e-mail contact information at step 266, which he or she uses to communicate with vendors and/or buyers. After taking the desired action buyer e-mail notification module 52, the food service professional is returned to buyer homepage 18 where he or she can select at least 1 of at least 8 options.

As shown in FIG. 4, buyer profile page 40 allows food service industry professionals to update their user profile at step 278 by inserting data at step 276.

As shown in FIG. 4, buyer order management page 28 allows a food service industry professional to copy orders at step 268, view orders at step 270, use orders at step 272, and delete orders at step 274. After taking the desired action at buyer order management page 28, the food service professional is returned to buyer homepage 18 where he or she can select at least 1 of at least 8 options.

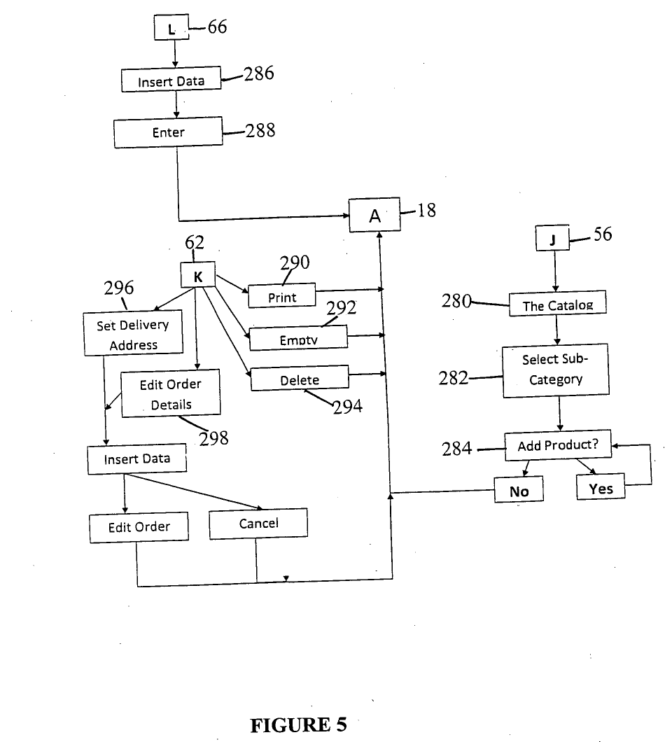

FIG. 5 illustrates how a buyer interested in purchasing products used in the food service industry uses a preferred embodiment of the system of the subject invention to purchase products using the catalog of the subject invention. In one embodiment of the present invention, after logging in a user name and password, a food service industry professional may access new order area 58 (not shown) which adds the order to the current page. Once a food service industry professional has created the new order, he or she selects the “use” order option, as shown in FIG. 3. After a food service industry professional selects the “use” order option, he or she may search for products to order by accessing either catalog module 56 or product search module 66.

If a food service industry professional opts to search for products to order by accessing catalog module 56, which provides a food service industry professional access to a catalog of products available from vendor at step 280, which he or she can navigate to find a specific item by using search terms or by selecting a sub-category at step 282. Once a desired product is found, the food service industry professional selects that product and quantity to add it to their order at step 284, which adds that product to a cart so that an order may be subsequently placed. If, on the other hand, a food service industry professional opts to search for products to order by accessing product search module 66, the subject invention allows food service industry professionals to search for products using a search engine by inserting data at step 286 which is entered at step 288. Once a desired product is found, the food service industry professional simply selects that product and the quantity to add it to their order, which adds that product to a cart so that an order may be subsequently placed.

As shown in FIG. 5, after products are added to a food service industry professional's cart, the food service industry professional may view the items in the cart by accessing view order module 62. From view order module 62, a food service industry professional may: (a) print order details at step 290; (b) delete the entire order by emptying the same at step 292; (c) delete an item from the order at step 294; (d) enter delivery details at step 296; or (e) edit order details at step 298.

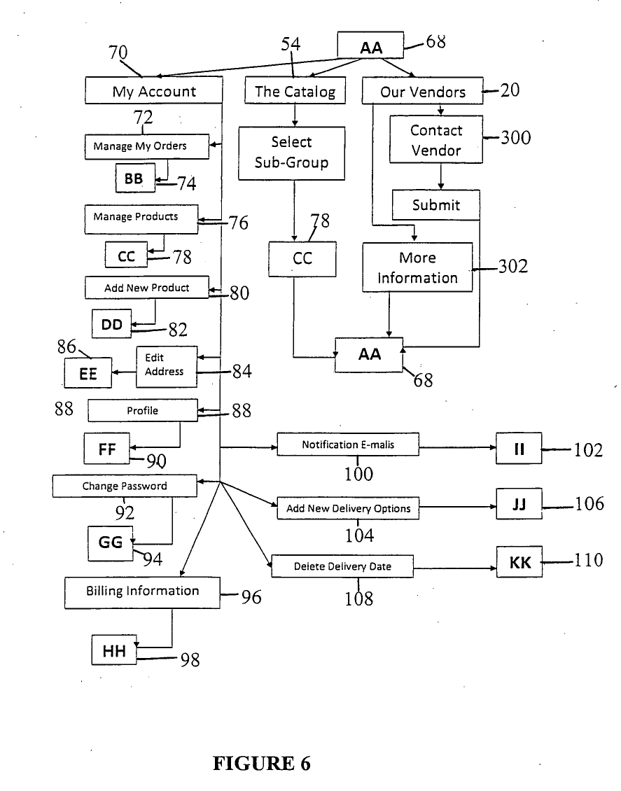

FIG. 6 illustrates use of a preferred embodiment of the system of the subject invention by a vendor/distributor. Specifically, after logging in using a user name and password, a vendor/distributor gains access to vendor homepage 68 which allows a vendor or distributor to choose from among the following: (a) vendor area 20 which directs the distributor or vendor to vendor module 22 which provides information regarding vendors and further allows a vendor or distributor to contact other vendors at step 300 or submit information about themselves at step 302; (b) vendor account area 70 which allows the vendor or distributor to choose among the following: (i) vendor/distributor order management area 72 which directs the vendor/distributor to vendor/distributor order management module 74 that allows a vendor/distributor to organize, process and track orders; (ii) new product area 80 which directs the vendor/distributor to new product module 82 that allows a vendor/distributor to add new products; (iii) manage product area 76 which directs the vendor/distributor to manage product module 78 that allows a vendor/distributor to modify or add information regarding the products they sell; (iv) edit address area 84 directs a vendor/distributor to edit address module 86 which allows a vendor/distributor to change their address; (v) vendor profile area 88 which directs the vendor to vendor profile module 90 that allows a vendor/distributor to update/modify their profile; (vi) vendor password link 92 which directs the vendor/distributor to vendor password page 94 that allows a vendor/distributor to change their user password; (vii) vendor billing information area 96 which directs the vendor/distributor to vendor billing information module 98 that allows a vendor/distributor to update/modify billing information; (viii) vendor e-mail notification area 100 which directs the vendor/distributor to vendor e-mail notification module 102 which allows a vendor/distributor to update/modify their e-mail contact information, which a vendor/distributor uses to communicate with food service industry professionals; (ix) delivery options area 104 directs a vendor/distributor to delivery options module 106 which allows a vendor/distributor to provide various delivery options to food service industry professional wishing to purchase a product or products; (x) delivery date area 108 directs a vendor/distributor to delivery date module 110 which allows a vendor/distributor to select a date in which an order is delivered to a food service industry professional; or (c) catalog area 54 which directs a vendor/distributor to catalog module 56 which provides the vendor/distributor access to a catalog listing their products.

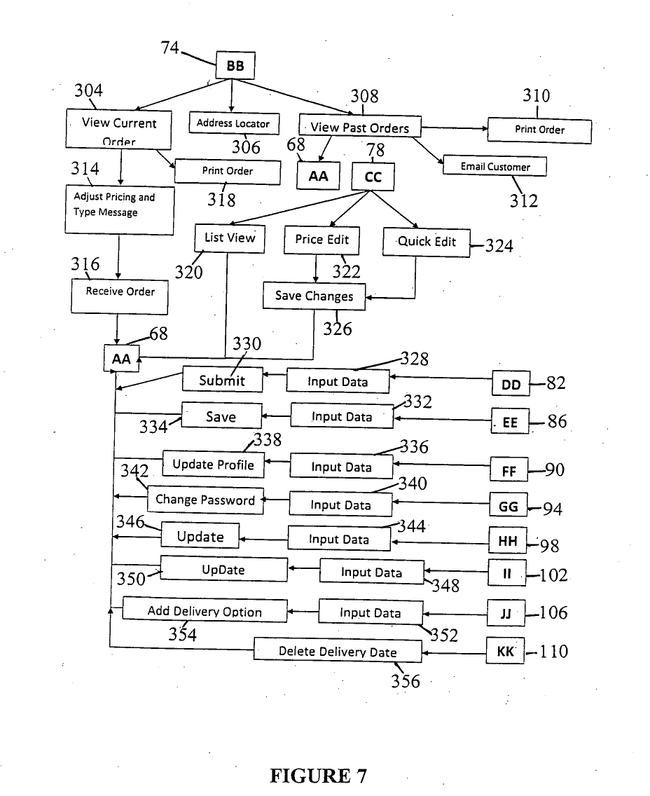

FIG. 7 illustrates use of a preferred embodiment of the system of the subject invention by a vendor/distributor. Specifically, after logging in using a user name and password, a vendor/distributor gains access to vendor/distributor order management module 74 via vendor/distributor area 72 (not shown) from vendor homepage 68. From vendor order management module 74 a vendor/distributor can: (a) view a current order placed with the vendor/distributor from a food service industry professional at step 304, which allows a vendor/distributor to adjust the pricing of the order after the order is placed with the vendor/distributor by a food service industry professional at step 314, receive orders at step 314, and/or print orders at step 318; (b) view an address locator at step 306; or (c) view past orders at step 308, which allows a vendor/distributor to subsequently either print order information at step 310, or contact the food service industry professional that placed the order at step 312 by, for example, e-mail. After taking the desired action at vendor order management module 74, the vendor/distributor is returned to vendor homepage 68 where he or she can select 1 of at least 8 options.

As shown in FIG. 7, vendors/distributors may access manage products module 78 which allows a vendor/distributor to (a) view their product list at step 320; (b) edit prices at step 322; and (c) edit product information at step 324. After taking the desired action at manage products page 78, any modified information and is saved at step 326, the vendor/distributor is returned to vendor homepage 68 where he or she can select at least 1 of at least 8 options.

As shown in FIG. 7, vendors/distributors may access new product module 82 which allows a vendor/distributor to add new products to their list of products available for purchase by food service industry professionals by inputting data at step 328 and submitting the same at step 330. After adding a new product at new product module 82, the vendor/distributor is returned to vendor homepage 68 where he or she can select at least 1 of at least 8 options.

As shown in FIG. 7, vendors/distributors may access edit address module 86 which allows a vendor/distributor to edit their address by inputting data at step 332 After editing an address, any modified information and is saved at step 334, the vendor/distributor is returned to vendor homepage 68 where he or she can select at least 1 of at least 8 options.

As shown in FIG. 7, vendors/distributors may access vendor profile module 90 which allows a vendor/distributor to update/modify their profile at step 338 by inputting data at step 336. Notably, vendor profile module 90 allows a vendor to select the location(s) in which the vendor provides good or services regardless of the vendor's physical location. Accordingly, food service industry professionals are not limited from ordering goods or services from vendors that are physically located in the food service industry professional's specific geographic location. Instead, food service industry professionals may order goods or services from any vendor which provides goods or services to a food service industry professional's location. It is recognized that vendors may use the system of the subject invention to tests markets in various geographic locations. Indeed, as discussed above, vendors may create their vendor profile to provide goods or services through the system of the subject invention in various geographic locations, including locations where the vendor is not physically located. As such, a vendor may choose to provide goods or services through the system of the subject invention to a specific geographic location in order to test the market for the vendors' goods or services in that location. After updating their profile at vendor profile module 90, the vendor/distributor is returned to vendor homepage 68 where he or she can select at least 1 of at least 8 options.

As shown in FIG. 7, vendors/distributors may access vendor password module 94 which allows a vendor/distributor to update/modify their password at step 340 by inputting data which is saved at step 342. After updating or modifying their password at vendor password module 94, the vendor/distributor is returned to vendor homepage 68 where he or she can select at least 1 of at least 8 options.

As shown in FIG. 7, vendors/distributors may access vendor billing information module 98 which allows a vendor/distributor to update/modify their billing information at step 346 by inputting data at step 344. After updating their billing information at vendor profile module 98, the vendor/distributor is returned to vendor homepage 68 where he or she can select at least 1 of at least 8 options.

As shown in FIG. 7, vendors/distributors may access vendor e-mail notification module 102 which allows a vendor/distributor to input data at step 348 in order to update/modify their e-mail contact information at step 350, which a vendor/distributor uses to communicate with food service industry professionals. After updating their e-mail contact information at vendor e-mail notification module 102, the vendor/distributor is returned to vendor homepage 68 where he or she can select at least 1 of more than 8 options.

As shown in FIG. 7, vendors/distributors may access delivery options module 106 which allows a vendor/distributor to provide various delivery options to food service industry professional wishing to purchase a product or products at step 354 by inputting data at step 352. After selecting the desired delivery option at delivery options module 106, the vendor is returned to vendor homepage 68.

As shown in FIG. 7, vendors/distributors may access delivery date module 110 which allows a vendor/distributor to delete a date in which an order is to be delivered to a food service industry professional at step 356. After selecting the delivery module 110, the vendor/distributor is returned to vendor homepage 68.

It will be understood that various modifications may be made to the embodiments disclosed herein. Therefore, the above description should not be construed as limiting, but merely as exemplification of the various embodiments. Those skilled in the art will envision other modifications within the scope and spirit of the claims appended hereto.

What is claimed is:

1. A purchasing system for food service industry professionals comprising:
a portal for a communication network, the portal including:
a buyer account registration area for processing buyer registrations;
a vendor account registration area for processing vendor registrations;
a login area for providing buyers and vendors access to either a buyer home area or a vendor home area;
a buyer area for providing information about buyers;
a vendor area for providing information about vendors;
a contact area for food service industry professionals and vendors to communicate;
an administrator contact area for communicating with a system administrator;
a system information area for providing information about the system to buyers and vendors; and
a system administrator area for providing information about the system administrators.

2. The system of claim 1, wherein said buyer account registration area includes:
a database of addresses for all vendors registered with the system; and
an address verification module which verifies a buyer's address then determines if there are any vendors which service a given location by comparing address information from the database of addresses for all vendors registered with the system and the buyer's address.

3. The system of claim 1, wherein said vendor account registration area includes:
a database of addresses for all buyers registered with the system; and
an address verification module which verifies a vendor's address and then determines if there are any buyers within the region(s) serviced by the vendors by comparing address information from the database of addresses for all buyers registered with the system and the vendor's address.

4. The system of claim 1, wherein said buyer home area includes:
a vendor module providing information about vendors;
a buyer account module which includes:
a buyer order management module for organizing, processing and tracking orders;
a preferred vendor module providing a list of preferred vendors;
a shipping location module for updating/modifying shipping information;
a buyer profile page for updating/modifying profiles;
a buyer password module for changing passwords;
a buyer billing information module for updating/modifying billing information; and
a buyer e-mail notification module updating/modifying e-mail contact information;
a catalog module providing a catalog listing products from vendors; and
a new order module for processing orders.

5. The system of claim 1, wherein said vendor home area includes:
a vendor module for providing information regarding vendors and communicating with other vendors;
a vendor account module which includes:
a vendor order management module for organizing, processing and tracking orders;
a new product module for adding new products;
a product management module adding/modifying information regarding the products;
an edit address module for changing/modifying addresses;
a vendor profile module for updating/modifying a profile;
a vendor password module for changing passwords;
a vendor billing information module for updating/modifying billing information;
a vendor e-mail notification module for updating/modifying e-mail contact information;
a delivery options module for providing delivery options; and
a delivery date module for viewing and modifying a delivery date; and
a catalog module for providing access to a catalog listing of products.

6. The system of claim 1, wherein vendors may provide buyers with custom quotes, specific to a given buyer.

7. The system of claim 1, wherein vendors may optimize pricing by allowing vendors to offer different prices to different buyers.

8. The system of claim 1, wherein said portal is an online web page.

9. The system of claim 1, wherein said portal further includes a news area for providing general information, product information, promotional information, information about buyers, or information about vendors.

10. The system of claim 5, wherein said vendor profile module allows a vendor to select the location(s) in which the vendor provides good or services regardless of the vendor's physical location.

11. A purchasing system for food service industry professionals comprising:
a portal for a communication network, the portal including:
a buyer account registration area for processing buyer registrations including:
a database of addresses for all vendors registered with the system; and,
an address verification module which verifies a buyer's address then determines if there are any vendors which service a given location by comparing address information from the database of addresses for all vendors registered with the system and the buyer's address;
a vendor account registration area for processing vendor registrations including:
a database of addresses for all buyers registered with the system; and,
an address verification module which verifies a vendor's address and then determines if there are any buyers within the region(s) serviced by the vendors by comparing address information from the database of addresses for all buyers registered with the system and the vendor's address;
a login area for providing buyers access to a buyer home area including:
a vendor module providing information about vendors; a buyer account module which includes:
a buyer order management module for organizing, processing and tracking orders;
a preferred vendor module providing a list of preferred vendors;
a shipping location module for updating/modifying shipping information;
a buyer profile page for updating/modifying profiles;
a buyer password module for changing passwords;
a buyer billing information module for updating/modifying billing information; and,
a buyer e-mail notification module updating/modifying e-mail contact information;
a login area for providing vendors access to a vendor home area including:
a vendor module for providing information regarding vendors and communicating with other vendors;
a vendor account module which includes:
a vendor order management module for organizing, processing and tracking orders;
a new product module for adding new products;
a product management module adding/modifying information regarding the products;
an edit address module for changing/modifying addresses;
a vendor profile module for updating/modifying a profile;
a vendor password module for changing passwords;
a vendor billing information module for updating/modifying billing information;
a vendor e-mail notification module for updating/modifying e-mail contact information;
a delivery options module for providing delivery options;
a delivery date for selecting a delivery date; and,
a catalog module for providing access to a catalog listing of products;
a buyer area for providing information about buyers;
a vendor area for providing information about vendors;
a contact area for food service industry professionals and vendors to communicate;
an administrator contact area for communicating with a system administrator;
a system information area for providing information about the system to buyers and vendors; and
a system administrator area for providing information about the system administrators.

12. A purchasing method for food service industry professionals comprising:
accessing a portal for a communication network, the portal comprising:
a buyer account registration module for processing buyer registrations;
a vendor account registration module for processing registrations;
a login module for providing buyers access to a buyer module including:
a vendor module providing information about vendors;
a buyer account module which includes:
a buyer order management module for organizing, processing and tracking orders;
a preferred vendor module providing a list of preferred vendors;
a shipping location module for updating/modifying shipping information;
a buyer profile page for updating/modifying profiles;
a buyer password module for changing passwords;
a buyer billing information module for updating/modifying billing information; and
a buyer e-mail notification module for updating/modifying e-mail contact information;
a catalog module providing a catalog listing products from vendors;
a new order module for processing orders;
a login module for providing vendors access to a vendor home area including:
a vendor order management module for organizing, processing and tracking orders;
a new product module for adding new products;
a product management module adding/modifying information regarding the products;
an edit address module for changing/modifying addresses;
a vendor profile module for updating/modifying a profile;
a vendor password module for changing passwords;
a vendor billing information module for updating/modifying billing information;
a vendor e-mail notification module for updating/modifying e-mail contact information;
a delivery options module for providing delivery options; and,
a delivery date for selecting a delivery date;
a catalog module for providing access to a catalog listing of products;
a product search module to search for product using a search engine;
a contact module for food service industry professionals and vendors to communicate;
an administrator contact module for communicating with a portal administrator; and,
a portal information module for providing information about the portal to buyers and vendors;
registering through either the buyer account registration module or the vendor account registration module;
accessing the vendor module to view information regarding a vendor;
accessing the buyer account module to choose among the following:
(i) a buyer order management module to organize, process and track orders;
(ii) a preferred vendor module providing a list of preferred vendors;
(iii) a shipping location module providing shipping information;
(iv) a buyer profile module to update/modify profile information;
(v) a buyer password module to change password information;
(vi) buyer billing information module to update/modify billing information;
(vii) buyer e-mail notification module to update/modify his or her e-mail contact information;
accessing the catalog area module to view a catalog listing products from vendors;
accessing new order area to create a new order by selecting a vendor logo which allows a food service industry professional to:
(a) search for products;
(b) get more information about a particular vendor;
(c) view a vendor's products; or
(d) contact a vendor; and,
selecting a product to purchase;
adding the selected product to a cart; and
ordering the products in the cart.

13. The method of claim 12, wherein said buyer account registration module includes:
a database of addresses for all vendors registered with the system; and
an address verification module which verifies a buyer's address then determines if there are any vendors which service a given location by comparing address information from the database of addresses for all vendors registered with the system and the buyer's address.

14. The method of claim 12, wherein said vendor account registration module includes:
a database of addresses for all buyers registered with the system; and
an address verification module which verifies a vendor's address and then determines if there are any buyers within the region(s) serviced by the vendors by comparing address information from the database of addresses for all buyers registered with the system and the vendor's address.

15. The method of claim 12, wherein vendors may provide buyers with custom quotes, specific to a given buyer.

16. The method of claim 12, wherein vendors may optimize pricing by allowing vendors to offer different prices to different buyers.

17. The method of claim 12, wherein said portal is an online web page.

18. The method of claim 12, wherein said portal further includes a news area for providing general information, product information, promotional information, Information about buyers, or Information about vendors.

19. The method of claim 12, wherein said vendor profile module allows a vendor to select the location(s) in which the vendor provides goods or services regardless of the vendor's physical location.

20. The method of claim 12, wherein products may be selected by searching for products to order by accessing either the catalog module or the product search module.
